(19) United States
(12) Patent Application Publication
(10) Pub. No.: US 2007/0126721 A1
(43) Pub. Date: Jun. 7, 2007

(54) Display module and electronic device using the same

(75) Inventor: Yoshiyuki Kurokawa, Sagamihara (JP)

Correspondence Address: COOK, ALEX, McFARRON, MANZO,;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 11/605,620

(22) Filed: Nov. 29, 2006

(30) Foreign Application Priority Data
Dec. 2, 2005 (JP) 2005-350046

(51) Int. Cl. G09G 5/00

(52) U.S. Cl. 345/204

(57) ABSTRACT

A display module is provided, which comprises a stacked printed circuit board, and a control circuit mounted on the stacked printed circuit board. The stacked printed circuit board includes at least a first printed wiring board, a second printed wiring board, and a flexible insulating substrate interposed between the first printed wiring board and the second printed wiring board. The flexible insulating substrate includes at least a first connecting portion and a second connecting portion. A display panel is electrically connected to one of the first connecting portion and the second connecting portion. The control circuit includes a memory. The control circuit supplies an electrical signal to the one of the first connecting portion and the second connecting portion in accordance with a data stored in the memory.

### TECHNICAL FIELD

The present invention relates to a display module and an electronic device using the display module. In particular, the present invention relates to a display module having a display panel including a TFT using a semiconductor thin film as an active layer, and an electronic device using such a display module.

### BACKGROUND ART

In recent years, research and development on a display panel, including a TFT (thin film transistor) that has a polycrystalline silicon thin film as an active layer, as a switching element in a pixel portion or an active matrix display panel in which circuits for driving pixels are formed in a periphery of a pixel portion has been actively carried out.

The biggest advantages of a display panel having a polycrystalline silicon thin film as described above are as follows: it is thin; it is thin and light-weight and has low power consumption. Utilizing such advantages, the display panel having a polycrystalline silicon thin film is used as a display panel in an electronic device such as a portable information-processing device typified by a notebook personal computer or a handheld game machine.

In an electronic device in which such a display panel is mounted, a printed wiring board (PWB) including a plurality of LSI chips, a capacitor element, a resistor element, a coil element, a power supply element, and the like is generally mounted (see Patent Document 1: Japanese Published Patent Application No. 2004-252339). In general, a printed wiring board is connected to a display panel via a flexible printed circuit board (hereinafter referred to as FPC). Hereinafter, an object constituted by a display panel, an FPC, and a printed wiring board combined together is referred to as a display module. As an example of the display module, a liquid crystal display panel (see Patent Document 1) or a self-luminous display panel (see Patent Document 2: Japanese Published Patent Application No. 2004-354684) can be given.

In addition, a stacked printed circuit board in which a printed wiring board and an FPC are combined is proposed (see Patent Document 3: Japanese Published Patent Application No. 2003-17852). This is a printed wiring board in which an FPC and a printed wiring board are formed as an integrated component, a portion corresponding to a normal FPC is formed over a flexible insulating substrate, and a portion corresponding to a normal printed wiring board is formed over an insulating hard substrate. The stacked printed circuit board has a flexible insulating substrate having bendability in the inner layer. The stacked printed circuit board is constituted by an FPC on which a predetermined wiring circuit is formed and printed wiring boards made by forming circuits over outer layers of insulating hard substrates that sandwich the FPC therebetween. It is cut and processed into a predetermined outline shape.

### DISCLOSURE OF INVENTION

A first conventional example of a display module is shown in FIG. 3. In the display module, a display panel 301 and a printed wiring board 303 are connected to each other by an FPC 302. The display panel 301 is a liquid crystal panel formed by interposing a liquid crystal layer between a pair of substrates, an EL panel in which organic EL elements are arranged, or the like, and has a display portion 304. A controller 307, a memory 308, a power supply circuit 309, a CPU 310 and the like are included in the printed wiring board 303. The display panel 301 and the FPC 302 are connected to each other by a thermosetting resin 311. The printed wiring board 303 is connected to the FPC 302 through a connector 312. At least one of a first pin or a first plug of the printed wiring board 303 or a second pin or a second plug of the FPC 302 is inserted the connector 312.

A second conventional example of a display module which uses a stacked printed circuit board is shown in FIG. 4. A stacked printed circuit board 401 in FIG. 4 is structured by interposing an FPC 402 formed by printing a wiring circuit on a polyimide film between printed wiring boards formed by printing wiring circuits on glass epoxy resin. A controller 307, a memory 308, a power supply circuit 309, and a CPU 310 are included in the stacked printed circuit board 401. The display panel 30 has a display portion 304. The display panel 301 and the FPC 402 are connected to each other with a thermosetting resin 311. In addition, the display panel 301 and the stacked printed circuit board 401 are connected to each other by the FPC 402.

However, as for conventional display modules, the wiring configuration of a printed wiring board on which a controller and the like are mounted, the circuit configuration of an FPC, and the number of pins in a connector portion are fixed, so that design changes are required every time a specification of a product is changed. In addition, the connecting direction of the printed wiring board and the display panel has to be changed in accordance with the mode of an electronic device such as a cell-phone.

That is, as for conventional display modules, even a slight change in design requires that the printed wiring board be designed from the beginning, which takes development time and leads to an increase in manufacturing costs. This kind of problem cannot be solved by simply improving each of the parts.

In view of the above-described problem, it is an object of the present invention to provide a display module which has a controller which can change the function and configuration of a logic circuit in a printed wiring board and has a plurality of connecting terminals for connecting the printed wiring board and a display panel and is capable of flexibly responding to a change in a signal processing function and an output direction of the printed wiring board, or an electronic device having such a display module.

One feature of the present invention is a display module including a stacked printed circuit board and a control circuit mounted on the stacked printed circuit board. The stacked printed circuit board includes a first printed wiring board, a second printed wiring board, and a flexible insulating substrate interposed between the first printed wiring board and the second printed wiring board. The flexible insulating substrate includes a first connecting edge (also referred to as a first connecting portion) and a second connecting edge (also referred to as a second connecting portion). The first connecting edge can be connected to a first display panel, and the second connecting edge can be connected to a second display panel. The control circuit includes a means of changing an electrical signal to be supplied to the first connecting edge and the second connecting edge. The control circuit includes a means of supplying an electrical signal to either the first connecting edge or the second connecting edge.

In the above-described display module, a connecting terminal (also referred to as a terminal) of a connecting edge of the first display panel may have a structure for connecting to a connecting terminal (also referred to as a terminal) of the first connecting edge. In addition, a connecting terminal (also referred to as a terminal) of a connecting edge of the second display panel may have a structure for connecting to a connecting terminal (also referred to as a terminal) of the second connecting edge.

One feature of the present invention is a display module including a stacked printed circuit board, and a control circuit mounted on the stacked printed circuit board. The stacked printed circuit board includes at least a first printed wiring board, a second printed wiring board, and a flexible insulating substrate interposed between the first printed wiring board and the second printed wiring board. The flexible insulating substrate includes at least a first connecting portion and a second connecting portion. At least one of a first display panel and a second display panel is electrically connected to one of the first connecting portion and the second connecting portion. The control circuit includes a memory. The control circuit supplies an electrical signal to the one of the first connecting portion and the second connecting portion in accordance with a data stored in the memory. The data stored in the memory is information about a function and a configuration of a logic circuit included in the control circuit.

Another feature of the present invention is a display module including a stacked printed circuit board and a control circuit mounted on the stacked printed circuit board. The stacked printed circuit board includes a first printed wiring board, a second printed wiring board, and a flexible insulating substrate interposed between the first printed wiring board and the second printed wiring board. The flexible insulating substrate includes n (n≧2) pieces of connecting edges. Each of the n pieces of connecting edges can be connected to a display panel. The control circuit includes a means of changing an electrical signal to be supplied to connecting edges which are connected to the display panel from among the n pieces of connecting edges. The control circuit includes a means of supplying an electrical signal only to connecting edges which are connected to the display panel from among the n pieces of connecting edges.

The display module of the present invention can be connected to the display panel by using one or both of the first connecting edge and the second connecting edge. In this case, when only one of the first connecting edge or the second connecting edge is used, a means of stopping a supply of an electrical signal to the connecting edge which is not connected to the display panel may be provided.

The display module of the present invention can change the function and configuration of a logic circuit and includes a control circuit (hereinafter also referred to as a controller) which can change an electrical signal to be supplied to the connecting edge, due to the change in the function and configuration of the logic circuit. A means of creating information about the function and configuration which determines the function and configuration of a logic circuit of the control circuit, based on first input information which represents a specification of an electrical signal supplied from the control circuit and second input information which represents placement information of an output terminal for outputting an electrical signal, may be provided. The information about the function and configuration is stored in a read only memory (hereinafter referred to as a ROM) mounted on the stacked printed circuit board or in a ROM in the control circuit.

The present invention is an electronic device which includes a display module having the above-described structure.

In accordance with the present invention, a stacked printed circuit board can be used in common for display panels with different specifications in a display module, and development costs or manufacturing costs of the display module can be reduced. Furthermore, by providing a plurality of connecting edges for the stacked printed circuit board, and making a controller, which can change the function and configuration of a logic circuit, be able to select where to output a signal, a connection structure with a display panel can be optimized in accordance with the size or mode of housing. Accordingly, the display module can be put in an electronic device compactly. Such effects offer flexibility in designing an electronic device and enable an electronic device with high quality appearance to be provided. In addition, through mounting of this kind of display module, an inexpensive and high-performance electronic device can be provided.

### BRIEF DESCRIPTION OF DRAWINGS

FIG. 1 is a first configuration diagram of a display module of the present invention.

FIG. 2 is a second configuration diagram of a display module of the present invention.

FIG. 3 shows a first example of a conventional display module.

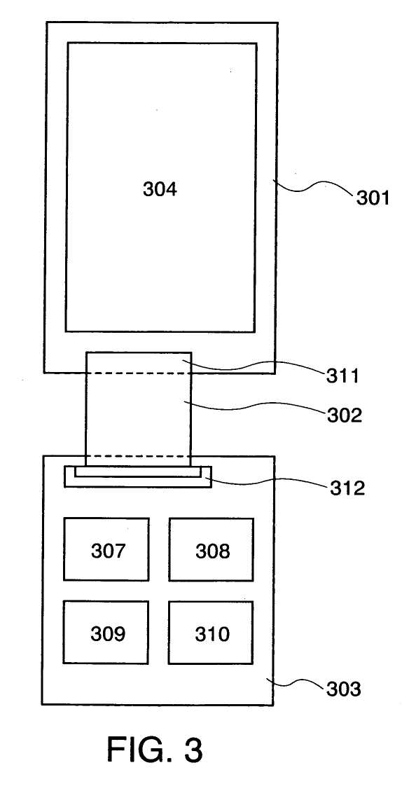

FIG. 4 shows a second example of a conventional display module.

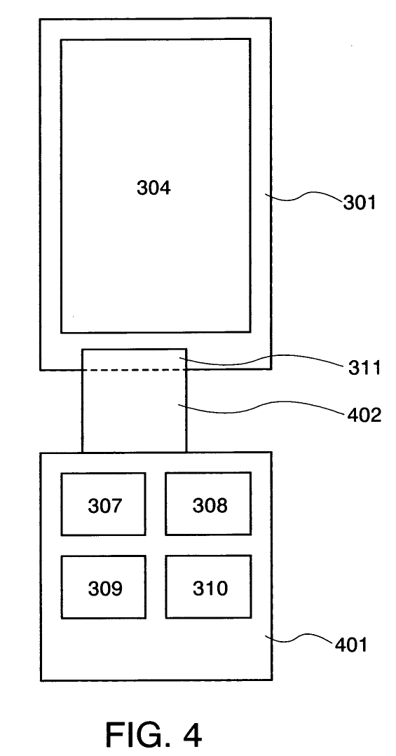

FIG. 5 shows a first circuit configuration of a display module of the present invention.

FIG. 6 shows a second circuit configuration of a display module of the present. invention.

FIG. 7 shows a third circuit configuration of a display module of the present invention.

FIG. 8 shows a liquid crystal display panel constituting a display module of the present invention.

FIG. 9 shows a self-luminous display panel constituting a display module of the present invention.

FIGS. 10A to 10 G each show an electronic device of the present invention.

FIG. 11 is a view showing a structure of a display module of the present invention.

### BEST MODE FOR CARRYING OUT THE INVENTION

An embodiment mode of the present invention will be described hereinafter with reference to the drawings. However, the present invention can be carried out in various modes, and it is easily understood by those skilled in the art that the modes and details can be changed in various ways without departing from the spirit and scope of the present invention. Therefore, the present invention is not interpreted as being limited to the following description of this embodiment mode. In all the drawings for describing this embodiment mode, the same reference numerals are used for denoting the same portions or portions having the same functions, and repeated descriptions thereof will be omitted.

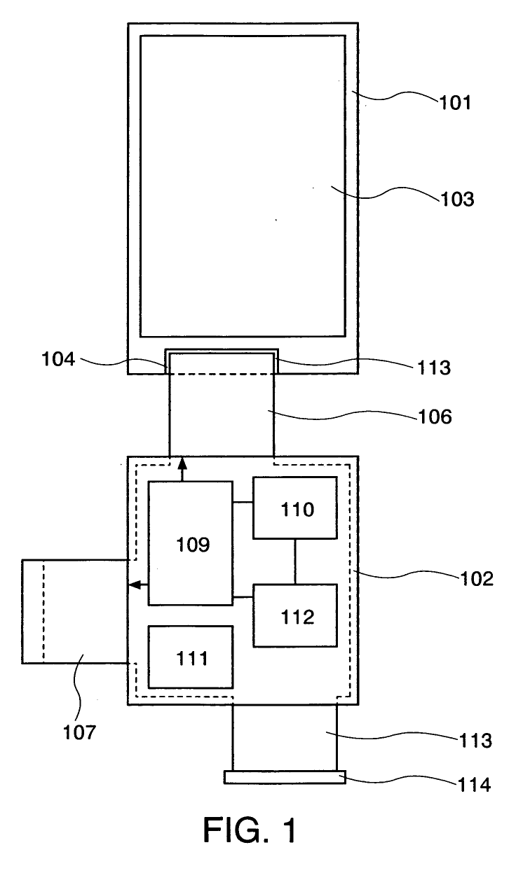

An embodiment mode of a display panel of the present invention will be described with reference to FIGS. 1, 2, and 11. FIGS. 1, 2, and 11 are configuration diagrams of a display module of the present invention.

FIG. 1 shows a display module including a stacked printed circuit board 102 and a first display panel 101. A controller 109, a memory 110, a power supply circuit 111, and a CPU 112 are mounted on the stacked printed circuit board 102. The stacked printed circuit board 102 has a structure in which a flexible insulating substrate is interposed between a first printed wiring board and a second printed wiring board. The flexible insulating substrate is formed by printing a wiring circuit on a polyimide film, an aramid film, a glass epoxy resin, a liquid crystal polymer, or the like. Each of the first printed wiring board and the second printed wiring board is formed by printing a wiring circuit on an insulating rigid substrate such as a glass epoxy resin. The above-described flexible insulating substrate corresponds to an FPC of a usual display module. That is, the stacked printed circuit board includes an FPC.

Among objects to be mounted on the stacked printed circuit board 102, the controller 109 generates an electrical signal required for driving the display panel 101 and outputs the signal from an input and output terminal. The memory 110 is used as a frame memory for image display or for a working area of the CPU 112. The power supply circuit 111 supplies a power supply voltage to the controller 109, the memory 110, and the CPU 112, and also supplies a power supply voltage required for driving the display panel 101. The CPU 112 performs image processing, processing of user application, or the like.

In FIG. 1, a first connecting edge 106 and a second connecting edge 107 are extended from the stacked printed circuit board 102 in different directions, acting as connecting portions with the display panel. In addition, a third connecting edge 113 for connection with another printed wiring board is extended from the other side of the stacked printed circuit board 102. The third connecting edge 113 is electrically connected to a connector 114.

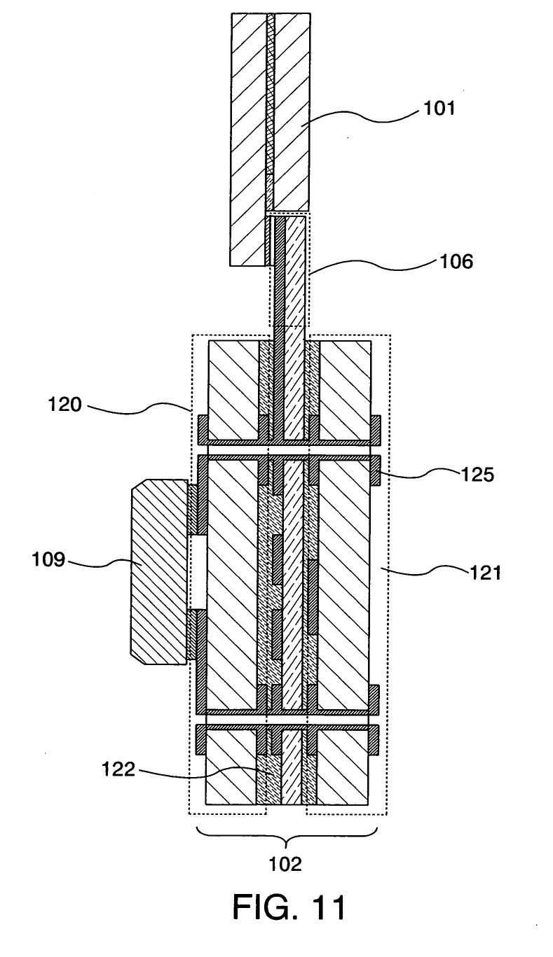

FIG. 11 shows a cross-sectional view of this kind of stacked printed circuit board 102. The stacked printed circuit board 102 has a structure in which a first printed wiring board 120 and a second printed wiring board 121 sandwich a flexible insulating substrate. The first connecting edge 106 of the flexible insulating substrate is connected to the first display panel 101. The first printed wiring board 120, the flexible insulating substrate, and the second printed wiring board 121 are fixed to each other with an adhesive 122. These printed wiring boards are electrically connected to each other through conductive materials 215. Components such as the controller 109 are mounted on a surface of the stacked printed circuit board 102. Through stacking of a plurality of printed wiring boards to form a wiring, a substantial area required for leading a wiring forming a circuit (a projected area of the stacked printed circuit board 102) can be decreased, which leads to miniaturization.

In the first connecting edge 106, freedom in space for a connecting portion with the first display panel 101 is ensured. Accordingly, a space or angle between the stacked printed circuit board 102 and the first display panel 101 can be set freely within a certain range (a range where the first connecting edge 106 can bend) because of flexibility of the first connecting edge 106. It is to be noted that the cross-sectional structure of the stacked printed circuit board shown in FIG. 11 is an example, and the number of wiring boards to be stacked, a wiring connection structure, or the like can be changed appropriately.

In FIG. 1, as the display panel 101, various panels can be used, such as a liquid crystal panel, an EL (electroluminescence) panel, an electronic ink (a contrast medium of which the contrast is changed by a voltage applied) panel, a display panel using an electrochromic material, a display panel using an electron source element (FED), or a display panel using plasma discharge (PDP).

In FIG. 1, the first display panel 101 has a rectangular display portion 103 that is long vertically. Therefore, the body of the first display panel 101 also has a rectangular shape that is long vertically, and the connecting terminal 104 of the first connecting edge 106 is provided on one short side thereof. The number of terminals in terminal 104 and the arrangement pitch are appropriately set depending on the number of pixels, a display color, and a display method of the display portion 103. For example, the number of connecting terminals required varies depending on the number of power lines for the display portion or the number of video signal lines.

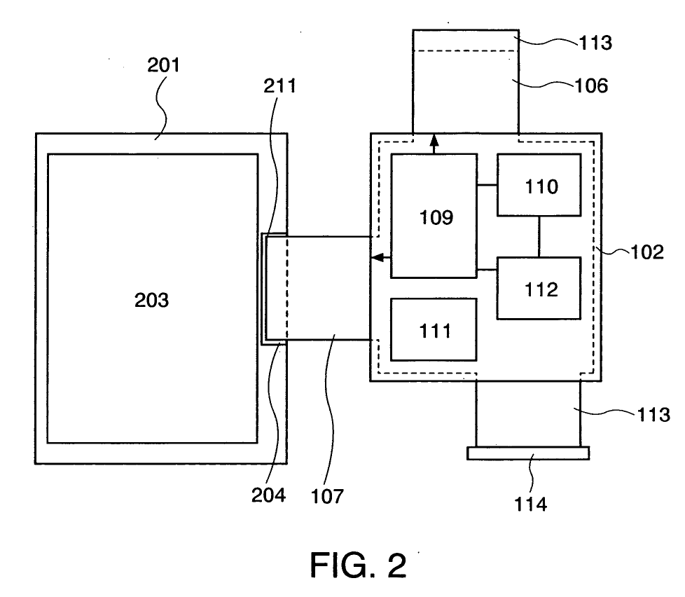

On the other hand, in FIG. 2, the second display panel 201 has a rectangular display portion 203 that is long horizontally, and a connecting terminal 204 is provided on one long side of the panel. Even in such a case, the second connecting edge 107 can be used for connecting the stacked printed circuit board 102 and the second display panel 201. The second connecting edge 107 has the connecting terminal 204. By making the number of connecting terminals and the arrangement pitch of the terminals vary between the first connecting edge and the second connecting edge of the stacked printed circuit board, the same stacked printed circuit board 102 can be applied to panels with different specifications.

In such a case, the switching of signals to be output to the plurality of connecting terminals extended from the stacked printed circuit board 102 is performed by the controller 109. Specifically, a semiconductor integrated circuit which can arbitrarily set the function and configuration of a logic circuit and the form of the input and output constitutes the controller 109. More specifically, an FPGA (Field Programmable Gate Array), a PLD (Programmable Logic Device), or a CPLD (Complex PLD) is used for the controller 109. As for the FPGA, PLD, and CPLD, information about the function and configuration of the logic circuit is stored in a ROM which is in the controller or an external ROM. By changing data in the ROM, the function and configuration of the logic circuit and input and output terminals of the controller can be changed. Accordingly, electrical signals can be changed arbitrarily.

In this embodiment mode, the ROM 507 is used as a memory medium for storing information about the function and configuration of the logic circuit; however, the present invention is not limited to this. One of a SRAM (Static Random Access Memory), a FeRAM (Ferroelectric Random Access Memory), a PROM (Programmable Read Only Memory), an EPROM (Electrically Programmable Read Only Memory), an EEPROM (Electrically Erasable Programmable Read Only Memory), and a flash memory is used as the memory medium. It is preferable to use an EPROM or an EEPROM.

The data to be stored in the ROM can be created by a software means (hereinafter referred to as a software or a logic synthesis layout routing tool). For example, first input information for which electrical signal timing and a logic circuit, which are required for driving a display panel connected to a connecting edge, are written in hardware description language (hereinafter referred to as HDL) and second input information for which layout information of input and output terminals which input and output the electrical signal is written are given to the logic synthesis layout routing tool, so that the data to be stored in the ROM can be generated. Then, by storing the data, a desired logic circuit can be constructed by the FPGA, PLD, or CPLD used as the controller 109. It is to be noted that the data stored in the ROM is information about the function and configuration of the logic circuit.

The controller 109 can be constituted by a semiconductor device which can change the function and configuration of the logic circuit, without being limited to the FPGA, PLD, or CPLD. The above-described semiconductor device changes the function and configuration of the logic circuit by electrically short-circuiting or insulating a wiring of the logic circuit in the controller 109, whereby an electrical signal required for driving a display panel can be changed arbitrarily.

Here, data to electrically short-circuit or insulate the wiring of the logic circuit can be created by a software means (hereinafter referred to as a logic synthesis short-circuit insulation tool). For example, first input information for which electrical signal timing and a logic circuit, which are required for driving a display panel connected to a connecting edge, are written in hardware description language (hereinafter referred to as HDL) and second input information for which layout information of input and output terminals which input and output the electrical signal are written are given to the logic synthesis short-circuit insulation tool, so that the data to electrically short-circuit or insulate the wiring of the logic circuit can be generated.

It is to be noted that a semiconductor device of which a portion includes similar functions, for example, an ASIC (Application Specific IC), a gate array or the like, of which a portion includes the FPGA, PLD, or CPLD, may be used for the controller 109.

In this way, the display module of the present invention can arbitrarily change an electrical signal which can be supplied to a connecting terminal, without changing hardware such as a physical shape of the controller 109 or an electrical connection.

Through use of the above-described structure, a stacked printed circuit board can be used in common for display panels with different specifications in a display module, and development costs or manufacturing costs of a display module can be reduced. Furthermore, by providing a plurality of connecting edges for the stacked printed circuit board and making a controller, which can change the function and configuration of a logic circuit, be able to select where to output a signal, a connection structure with a display panel can be optimized in accordance with the size or mode of housing.

Here, in the case of the structure of FIG. 1, that is, when the first display panel is connected only to the first connecting edge 106, electrical signals such as a control signal and an image signal that are required for driving the first display panel are supplied from the connecting terminal of the first connecting edge 106 to the first display panel 101. Then, the function and configuration of the logic circuit may be changed so that electrical signals from the second connecting edge 107 are not supplied to the first display panel 101.

That is, the first input information for which an electrical signal that is required for driving the first display panel 101 is written in HDL and the second input information for the layout of input and output terminals which input and output the electrical signal are given to the logic synthesis layout rooting tool, the data to be stored in the ROM is created, and the data may be stored in the ROM. At this time, the data stored in the ROM is information that no electrical signal is supplied from the connecting terminal of the second connecting edge 107. The second connecting edge 107 becomes unnecessary, so that it may be removed.

Further, in the case of the structure in FIG. 2, that is, when the second display panel 201 is connected to the second connecting edge 107, electrical signals such as a control signal and an image signal required for driving the second display panel 201 are supplied from the connecting terminal of the second connecting edge 107. Then, the data stored in the ROM is information that no electrical signal is supplied from the connecting terminal of the first connecting edge 106.

That is, the first input information for which an electrical signal that is required for driving the second display panel 201 is written in HDL and the second input information for the layout of input and output terminals which input and output the electrical signal are given to the logic synthesis layout rooting tool, the data to be stored in the ROM is created, and the data may be stored in the ROM. At this time, the data stored in the ROM is information that no electrical signal is supplied from the connecting terminal of the first connecting edge 106. The first connecting edge 106 becomes unnecessary, so that it may be removed.

Further, when the first display panel 101 and the second display panel 201 are connected to the first connecting edge 106 and the second connecting edge 107 respectively, the function and configuration of the logic circuit may be changed so that electrical signals such as a control signal and an image signal that are required for driving the first display panel 101 and the second display panel 201 are supplied from the connecting terminals of the first connecting edge 106 and the second connecting edge 107 respectively. That is, data to be stored in the ROM is created by using the first input information for which the above-described function is written in HDL, the second input information for input and output of an electrical signal, and the logic synthesis layout rooting tool, and the data may be stored in the ROM. It is to be noted that a display module having a two-screen display function can be formed in this case.

In addition, a structure in which a plurality of different display panels, not only the first display panel 101, can be connected to the first connecting edge 106 may be employed. That is, a structure in which a third display panel and a fourth display panel can each be connected to the first connecting edge 106 may be employed.

Here, each of the third and fourth panels has a connecting terminal of which the physical layout is the same as that of the connecting terminal of the first connecting edge 106. Moreover, when connection is made with a thermosetting resin, connecting terminals in the first connecting edge 106 and the connecting terminals of the display panels are electrically connected, respectively.

Further, a structure in which a plurality of different display panels, not only the second display panel 201, can be connected to the second connecting edge 107 may be employed. That is, a structure in which a fifth display panel and a sixth display panel can each be connected to the second connecting edge 107 may be employed.

Here, each of the fifth and sixth panels has a connecting terminal of which the physical layout is the same as that of the connecting terminal of the second connecting edge 107. Moreover, when connection is made with a thermosetting resin 211, connecting terminals in the second connecting edge and the connecting terminals of the display panels are electrically connected, respectively. This case can be dealt with by changing the function and configuration of the logic circuit of the controller 109. That is, the first input information for which an electrical signal that is required for driving the display panels is written in HDL and the second input information for the layout of input and output terminals which input and output the electrical signal are given to the logic synthesis layout rooting tool, data to be stored in the ROM is created, and the data may be stored in the ROM.

It is to be noted that, when display panels with different specifications are connected to the same connecting edge, there can be a case where not only an electric specification such as timing of the electrical signal required for driving the display panels but also the number of wirings supplying an electrical signal is different. In such a case, connecting terminals may be provided in the connecting edge in accordance with the number of wirings supplying an electrical signal of a display panel which requires the most wirings, among the display panels that can be connected to the connecting edge, and be electrically connected to the input and output terminals of the controller 109, respectively. When such a structure is employed and a display panel which requires the least number of wirings supplying an electrical signal for driving the display panel is connected to the connecting edge, the input and output terminal of the controller 109, connected to an unnecessary wiring, is not used.

Also in the above-described case, the first input information for which an electrical signal that is required for driving the display panels connected to the connecting edge is written in HDL and the second input information for the layout of input and output terminals which input and output the electrical signal are given to the logic synthesis layout rooting tool, data to be stored in the ROM is created, and the data may be stored in the ROM.

Although a description of the stacked printed circuit board having two connecting edges on the flexible insulating substrate is made in this embodiment mode, the number of connecting edges is not limited to two. That is, a display module which has n (n≧2) pieces of connecting edges on the flexible insulating substrate so that a display panel can be connected to each of the n pieces of connecting edges can be made. In this case, a display panel is connected to each of one or more arbitrary connecting edges from among the n pieces of connecting edges included in the display module, and the function and configuration of the logic circuit may be changed so as to supply electrical signals such as a control signal and an image signal required for driving a display panel to connecting terminals of the connecting edges which are connected to the display panels only, so as not to supply the electrical signal to connecting terminals of the other connecting edges. It is to be noted that a specification of the display panel to be connected is not limited to one kind.

That is, the first input information for which an electrical signal that is required for driving the display panels connected to the arbitrary connecting edges is written in HDL and the second input information for the layout of input and output terminals which input and output the electrical signal are given to the logic synthesis layout rooting tool, data to be stored in the ROM is created, and the data may be stored in the ROM.

Here, each of the display panels connected to the n pieces of connecting edges has a connecting terminal of which the physical layout is the same as that of the connecting terminal in each of the connecting edges that are connected. Moreover, when connection is made with a thermosetting resin, the connecting terminals of the display panel and the connecting terminals of the connecting edge are electrically connected to each other. At this time, a connecting terminal to which a display is not connected is unnecessary, so it may be removed.

Additionally, in general, a display module which can connect display panels with specifications of m (m≧1) kinds to one connecting edge can be made. In this case, the function and configuration of the logic circuit may be changed so as to supply electrical signals such as a control signal and an image signal required for driving the display panels to the connecting edge, in accordance with the specifications of the connected display panels.

That is, the first input information for which an electrical signal that is required for driving the connected display panels is written in HDL and the second input information for the layout of input and output terminals which input and output the electrical signal are given to the logic synthesis layout rooting tool, data to be stored in the ROM is created, and the data may be stored in the ROM. Here, each of the m pieces of display panels connected to the connecting edge has a connecting terminal of which the physical layout is the same as that of the connecting terminal in the connected edge. Moreover, when connection is made with a thermosetting resin, the connecting terminals of the display panel and the connecting terminals of the connecting edge are electrically connected to each other.

In the display module of the present invention having the structure described above, a printed wiring board can be used in common for display panels with different specifications, and development costs and manufacturing costs of a display module can be reduced. Therefore, an inexpensive and high-performance display module can be provided. Furthermore, by mounting such a display module, an inexpensive and high-performance electronic device can be provided.

### Embodiment 1

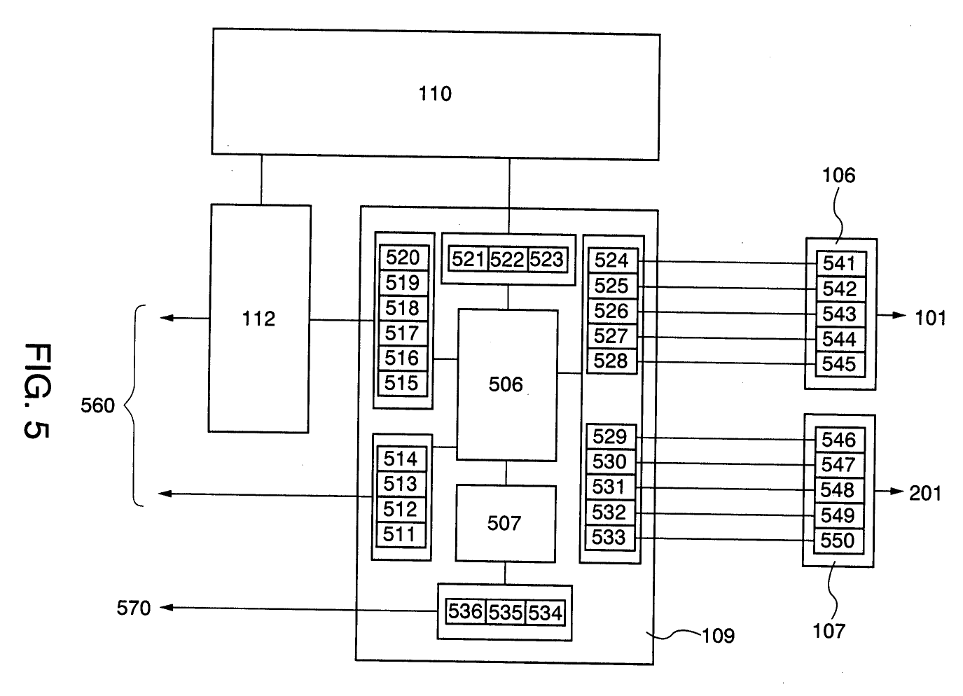

In this embodiment, a circuit configuration of the display module of the present invention which is described in Embodiment Mode will be explained with reference to FIG. 5. FIG. 5 is a circuit diagram for explaining in detail about a change in a logic circuit and input and output terminals of a controller, which is a characteristic portion of the display module of the present invention. It is to be noted that the same portions as in FIGS. 1 and 2 described in Embodiment Mode are denoted by the same reference numerals, and the repeated description will be omitted.

In FIG. 5, a controller 109 includes a logic circuit 506, a ROM 507, and first to 26th input and output terminals 511 to 536. A first connecting edge 106 is connected to a first display panel 101. The first connecting edge 106 is constituted by first to fifth connecting terminals 541 to 545. A second connecting edge 107 is connected to a second display panel 201. The second connecting edge 107 is constituted by sixth to tenth connecting terminals 546 to 550. The first to fourth input and output terminals 511 to 514 are electrically connected to a system 560 of an electronic device mounting the display module.

Specifically, each of the first to fourth input and output terminals 511 to 514 is electrically connected to a user interface or another printed wiring board. Each of the fifth to tenth input and output terminals 515 to 520 is electrically connected to a CPU 112. Each of the 11th to 13th input and output terminals 521 to 523 is electrically connected to a memory 110. The 14th to 18th input and output terminals 524 to 528 are electrically connected to the first to fifth connecting terminals 541 to 545, respectively. The 19th to 23rd input and output terminals 529 to 533 are electrically connected to the sixth to tenth connecting terminals 546 to 550, respectively.

Each of the 24th to 26th input and output terminals 534 to 536 is connected to a ROM writer 570 that can change data stored in the ROM 507. The ROM writer 570 may be incorporated in the electronic device mounting the display module. Alternatively, a structure in which each of the 24th to 26th input and output terminals 534 to 536 is connected to an external ROM writer only when the data stored in the ROM 507 is to be changed so that the data is changed may be employed.

It is to be noted that the ROM 507 is used as the memory medium for storing information about the function and configuration of the logic circuit in this embodiment mode; however, the present invention is not limited to this. One of a SRAM, a FeRAM, a PROM, an EPROM, an EEPROM, and a flash memory is used as the memory medium. It is preferable to use an EPROM or an EEPROM.

It is to be noted that the number of input and output terminals in the controller 109 shown in FIG. 5 is an example, and it may be any number depending on the actual embodiment mode. The specific number may be appropriately determined by a practitioner within a scope not departing from the content disclosed in the present specification.

The function and configuration of the logic circuit 506 of the controller 109 is determined by the data stored in the ROM 507. By changing the data stored in the ROM 507, the function and configuration of the logic circuit 506 of the controller 109 can be changed. As the function and configuration of the logic circuit 506, for example, timing of an electrical signal supplied from each of the first to 26th input and output terminals 511 to 536 and the logic circuit of the controller can be freely changed. Therefore, it is possible to change locations of the input and output terminals from which the electrical signal is supplied. It is to be noted that, although the case where the ROM 507 is incorporated in the controller 109 is shown in FIG. 5, the ROM may be mounted on a stacked printed circuit board, separately from the controller. Further, although an example of the case where the function and configuration of the logic circuit 506 of the controller 109 are changed following the data stored in the ROM 507 is described in this embodiment, the controller 109 may be constituted by a semiconductor device which can change the function and configuration of the logic circuit by electrically short-circuiting or insulating a wiring of the logic circuit 506 of the controller 109. For example, an ASIC (Application Specific IC) or a gate array, of which a portion includes an FPGA, a PLD, or a CPLD may constitute the controller 109.

In the display module of this embodiment having the structure described above, a stacked printed circuit board can be used in common for display panels with different specifications, and development costs and manufacturing costs of the display module can be reduced. Therefore, an inexpensive and high-performance display module can be provided. Furthermore, by mounting such a display module, an inexpensive and high-performance electronic device can be provided.

### Embodiment 2

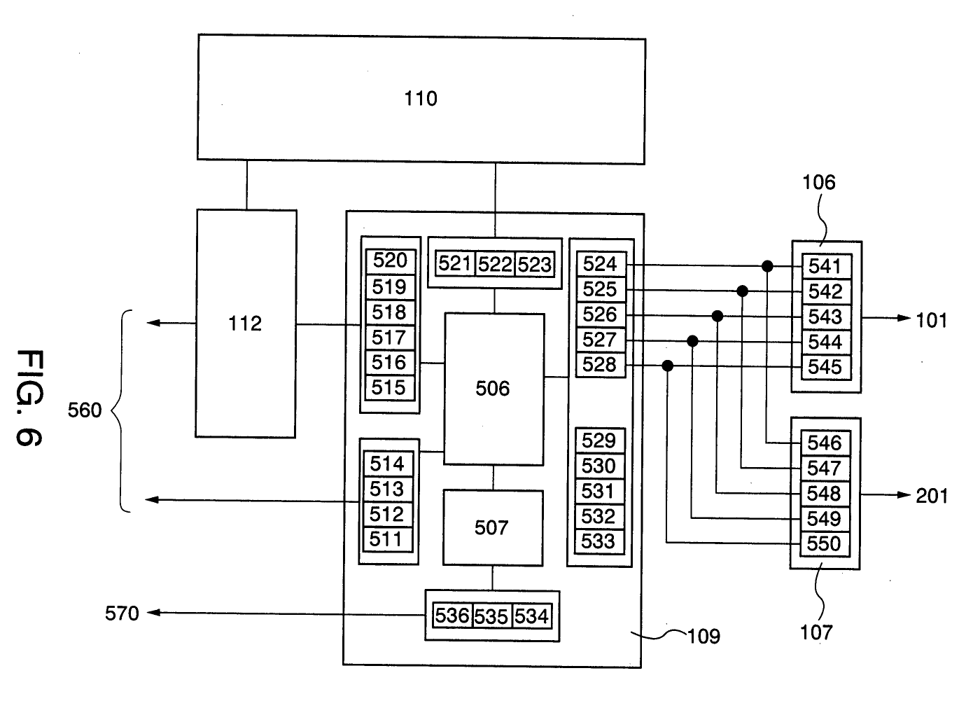

In this embodiment, an example of a circuit configuration of the display module of the present invention described in Embodiment Mode, which is different from the one described in Embodiment 1, will be described with reference to FIG. 6. FIG. 6 is a circuit diagram for explaining in detail about a change in a logic circuit and input and output terminals of a controller, which is a characteristic portion of the display module of the present invention. Further, 19th to 23rd input and output terminals 529 to 533 are not electrically connected to a connecting terminal. It is to be noted that the same portions as in FIGS. 1 and 2 described in Embodiment Mode and FIG. 5 described in Embodiment 1 are denoted by the same reference numerals, and the repeated description will be omitted.

It is to be noted that the data stored in the ROM 507 is information that 19th to 23rd input and output terminals 529 to 533 are not electrically connected to a connecting terminal. It is to be noted that the ROM 507 is used as the memory medium for storing information about the function and configuration of the logic circuit in this embodiment mode; however, the present invention is not limited to this. One of a SRAM, a FeRAM, a PROM, an EPROM, an EEPROM, and a flash memory is used as the memory medium. It is preferable to use an EPROM or an EEPROM.

In FIG. 6, a 14th input and output terminal 524 is electrically connected to a first connecting terminal 541 and a sixth connecting terminal 546. In the same way, 15th to 18th input and output terminals 525 to 528 are electrically connected to second to fifth connecting terminals 542 to 545 and seventh to tenth connecting terminals 547 to 550, respectively. The circuit configuration of the display module in FIG. 6 is different from the circuit configuration shown in FIG. 5 described in Embodiment 1, in the above-described way.

As the above, a connecting terminal of a first connecting edge 106 and a connecting terminal of a second connecting edge 107 receive a common electrical signal from the same input and output terminal, therefore the number of wirings over a stacked printed circuit board can be decreased. Accordingly, design expenses and manufacturing costs of the stacked printed circuit board can be reduced, which is effective.

It is to be noted that the number of input and output terminals in the controller 109 shown in FIG. 6 is an example, and it may be any number depending on the actual embodiment mode. The specific number may be appropriately determined by a practitioner within a scope not departing from the content disclosed in the present specification.

In the display module of this embodiment having the structure described above, a stacked printed circuit board can be used in common for display panels with different specifications, and development costs and manufacturing costs of the display module can be reduced. Therefore, an inexpensive and high-performance display module can be provided. Furthermore, by mounting such a display module, an inexpensive and high-performance electronic device can be provided.

### Embodiment 3

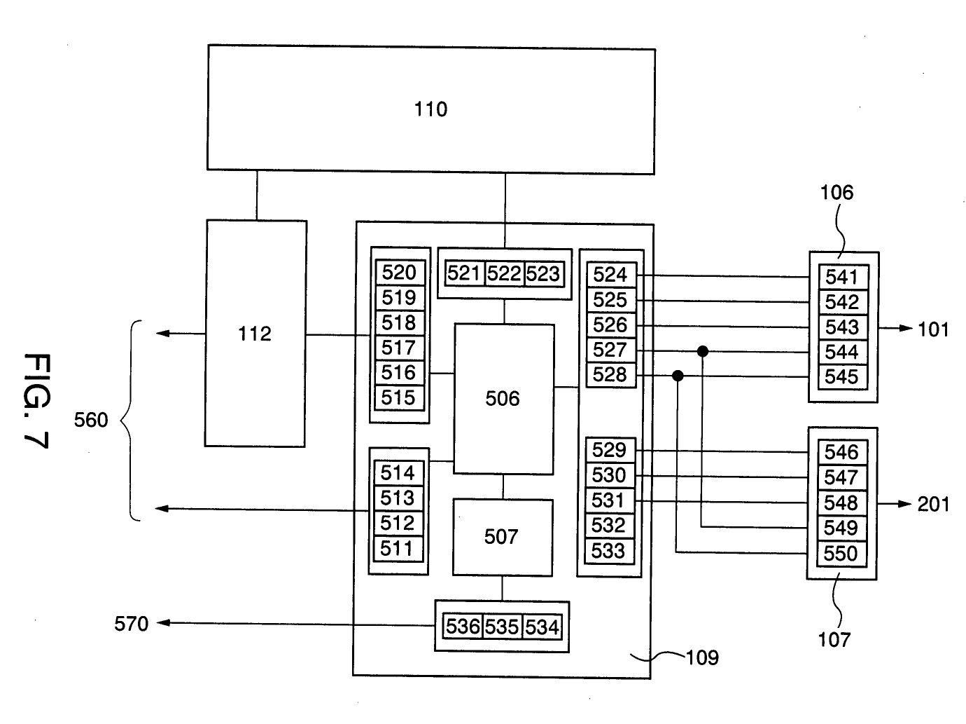

In this embodiment, an example of a circuit configuration of the display module of the present invention described in Embodiment Mode, which is different from the ones described in Embodiments 1 and 2, will be described with reference to FIG. 7. FIG. 7 is a circuit diagram for explaining in detail about a change in a logic circuit and input and output terminals of a controller, which is a characteristic portion of the display module of the present invention. It is to be noted that the same portions as in FIGS. 1 and 2 described in Embodiment Mode, FIG. 5 described in Embodiment 1, and FIG. 6 described in Embodiment 2 are denoted by the same reference numerals, and the repeated description will be omitted.

In FIG. 7, 14th to 16th input and output terminals 524 to 526 are electrically connected to first to third connecting terminals 541 to 543, respectively. Nineteenth to 21st input and output terminals 529 to 531 are electrically connected to sixth to eighth connecting terminals 546 to 548, respectively. A 17th input and output terminal 527 is electrically connected to a fourth connecting terminal 544 and a ninth connecting terminal 549. An 18th input and output terminal 528 is electrically connected to a fifth connecting terminal 545 and a tenth connecting terminal 550. Further, 22nd input and output terminal 532 and 23rd input and output terminal 533 are not electrically connected to a connecting terminal. The circuit configuration of the display module in FIG. 7 is different from the circuit configuration shown in FIG. 5 described in Embodiment 1 and the circuit configuration shown in FIG. 6 described in Embodiment 2, in the above-described way.

It is to be noted that the data stored in the ROM 507 is information that 22nd input and output terminal 532 and 23rd input and output terminal 533 are not electrically connected to a connecting terminal. It is to be noted that the ROM 507 is used as the memory medium for storing information about the function and configuration of the logic circuit in this embodiment mode; however, the present invention is not limited to this. One of a SRAM, a FeRAM, a PROM, an EPROM, an EEPROM, and a flash memory is used as the memory medium. It is preferable to use an EPROM or an EEPROM.

As the above, a connecting terminal of a first connecting edge 106 and a connecting terminal of a second connecting edge 107 receive a common electrical signal from some of the input and output terminals; therefore the number of wirings over a stacked printed circuit board can be decreased. The stacked printed circuit board can be used in common even when only a part of electrical signals supplied from connecting terminals of connecting edges to display panels respectively is common to a first display panel connected to the first connecting edge 106 and a second display panel connected to the second connecting edge 107. Accordingly, design expenses and manufacturing costs of the stacked printed circuit board can be reduced, which is effective.

It is to be noted that the number of input and output terminals in the controller 109 shown in FIG. 7 is an example, and it may be any number depending on the actual embodiment mode. The specific number may be appropriately determined by a practitioner within a scope not departing from the content disclosed in the present specification.

In the display module of this embodiment having the structure described above, a stacked printed circuit board can be used in common for display panels with different specifications, and development costs and manufacturing costs of the display module can be reduced. Therefore, an inexpensive and high-performance display module can be provided. Furthermore, by mounting such a display module, an inexpensive and high-performance electronic device can be provided.

### Embodiment 4

In this embodiment, a structure of a liquid crystal display panel that is applied to a display panel constituting the display module of the present invention described in Embodiment Mode and Embodiments 1 to 3 will be described.

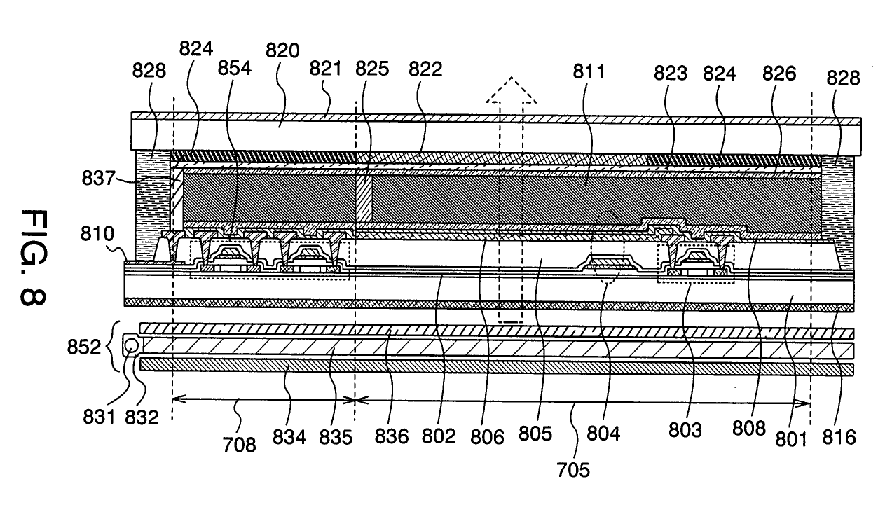

FIG. 8 shows a cross-sectional view of the liquid crystal display panel constituting the display module of the present invention.

The liquid crystal display panel includes a pixel portion 705 and a driver circuit portion 708. The pixel portion 705 corresponds to the display portion 103 in FIG. 1 and the display portion 203 in FIG. 2 described in Embodiment Mode. The driver circuit portion 708 corresponds to a source driver and a gate driver. The source driver inputs a video signal to the pixel portion, and the gate driver inputs a scanning signal to the pixel portion. In the pixel portion 705 and the driver circuit portion 708, a base film 802 is formed over an insulating substrate 801. As the insulating substrate 801, an insulating substrate formed by coating a surface of any of the following with an insulating film: a single-crystal semiconductor substrate, a quartz substrate, a glass substrate, a plastic substrate, a stainless substrate, or an SOI substrate; or the like can be used. Generally, there is concern that a substrate formed of a synthetic resin has a low heatproof temperature compared to the other substrates. However, the substrate formed of a synthetic resin can be used, by displacing after a manufacturing step using a substrate with high heat resistance.

A transistor to be a switching element is formed over the base film 802 in the pixel portion 705. In this embodiment, a thin film transistor (TFT) is used as the switching element, and referred to as a switching TFT 803. A TFT can be manufactured by various methods and with various structures. For example, a structure in which a crystalline semiconductor film is used as an active layer can be employed. Needless to say, the crystalline state of the active layer may be any of an amorphous state, or a microcrystalline state, in addition to a crystalline state.

A gate electrode is formed over the crystalline semiconductor film, with a gate insulating film therebetween. An inorganic material is preferably used for the gate insulating film, and silicon nitride, or silicon oxide may be used. The gate electrode is formed using a conductive material, including tungsten, tantalum, aluminum, titanium, silver, gold, molybdenum, or the like. By using the gate electrode, an impurity element can be added to the active layer. By adding the impurity element using the gate electrode in this manner, a mask for impurity element addition is not required to be formed. The gate electrode may have a single layer structure or a stacked layer structure. An impurity region may be either a high concentration impurity region or a low concentration impurity region, by controlling a concentration of the impurity. A TFT having a low concentration impurity region is referred to as an LDD (Light Doped Drain) structure. It is to be noted that a low concentration impurity region can be formed so as to overlap a gate electrode, and such a structure of a TFT is referred to as a GOLD (Gate Overlapped LDD) structure. In FIG. 8, the switching TFT 803 that has the GOLD structure is shown. The conductivity type of the switching TFT 803 is made to be an n-type by using phosphorus (P) or the like for the impurity region. When the conductivity type of the switching TFT 803 is made to be a p-type, boron (B) or the like is added.

After that, a protective film covering the gate electrode and the like is formed. A dangling bond of a crystalline semiconductor film can be terminated by a hydrogen element mixed in the protective film. Furthermore, an interlayer insulating film 805 may be formed to increase flatness. The interlayer insulating film 805 can be formed using an organic material, an inorganic material, or a stacked layer structure thereof. As the inorganic material, silicon nitride or silicon oxide can be used. As the organic material, polyimide, acrylic, polyamide, polyimide amide, resist, or benzocyclobutene, siloxane, polysilazane may be used. Siloxane has a skeleton structure formed by the bond of silicon (Si) and oxygen (O), in which an organic group containing at least hydrogen (an alkyl group, or aromatic hydrocarbon, for example) is used as a substituent. Alternatively, a fluoro group may be used as a substituent. Further alternatively, an organic group containing at least hydrogen and a fluoro group may be used as substituents. Polysilazane is formed using a liquid material containing a polymer material having the bond of silicon (Si) and nitrogen (N), as a starting material. When the inorganic material is used for forming the interlayer insulating film 805, the surface becomes uneven along the unevenness underneath. When the organic material is used for forming the interlayer insulating film 805, the surface becomes flat. For example, when flatness is required for the interlayer insulating film 805, the organic material may be used. It is to be noted, however, that flatness can be achieved even when the inorganic material is used for forming the interlayer insulating film 805, by forming the film thick.

Then, an opening is formed in the interlayer insulating film 805, the protective film, and the gate insulating film, and a wiring connected to the impurity region is formed. The switching TFT 803 can be formed in this manner. It is to be noted that the present invention is not limited to the structure of the switching TFT 803.

A conductive layer is formed in the opening provided in the interlayer insulating film 805 and the like, thereby forming a source electrode or a drain electrode. Then, a pixel electrode 806 that is connected to the source electrode or the drain electrode is formed.

A capacitor element 804 can be formed simultaneously with the switching TFT 803. In this embodiment, the capacitor element 804 is formed of a stacked body including a conductive film formed simultaneously with the gate electrode, the protective film, the interlayer insulating film 805, and the pixel electrode 806.

The pixel portion and the driver circuit portion can be formed over one substrate by using a crystalline semiconductor film. In this case, a transistor in the pixel portion and a transistor in the driver circuit portion 708 are formed simultaneously. The transistors used for the driver circuit portion 708 constitute a CMOS circuit; therefore, they are referred to as a CMOS circuit 854. Each TFT which constitutes the CMOS circuit 854 may have a similar structure to the switching TFT 803. Needless to say, the transistor constituting the CMOS circuit 854 does not necessarily have a similar structure to the switching TFT 803, and the LDD structure may be used instead of the GOLD structure, for example.

An alignment film 808 is formed so as to cover the pixel electrode 806. The alignment film 808 is subjected to rubbing treatment. This rubbing treatment is not performed in some cases, depending on a mode of liquid crystal. For example, the treatment is not required to be performed in a case of a VA mode.

Next, a counter substrate 820 is provided. A color filter 822 and a black matrix (BM) 824 can be provided inside the counter substrate 820, that is on the side which is in contact with a liquid crystal. The color filter and the like can be formed by known methods; however, a droplet discharging method (representatively an ink-jet method) by which a predetermined material is dropped can eliminate the waste of the material and an exposure step of a photolithography method. It is to be noted that the color filter and the like are provided in a region where the switching TFT 803 is not provided. That is to say, the color filter and the like are provided so as to face a light-transmissive region, which is an opening region. Furthermore, it is to be noted that the color filter and the like may be formed of materials which exhibit red (R), green (G), and blue (B) when a liquid crystal display device performs full-color display, and a material which exhibits at least one color in a case of mono-color display.

It is to be noted that a diode (LED) of RGB and the like are arranged in a backlight. The color filter is not provided in some cases when a successive additive color mixing method (field sequential method) in which color display is performed by time division is employed. The black matrix 824 is provided to reduce reflection of external light due to the wiring of the switching TFT 803 and the CMOS circuit 854. Therefore, the black matrix 824 is provided so as to overlap the switching TFT 803 or the CMOS circuit 854. It is to be noted that the black matrix 824 may be provided so as to overlap the capacitor element 804. Accordingly, reflection by a metal film constituting the capacitor element 804 can be prevented.

Then, a counter electrode 823 and an alignment film 826 are provided. The alignment film 826 is subjected to rubbing treatment.

It is to be noted that the wire included in the TFT, the gate electrode, the pixel electrode 806, and the counter electrode 823 can be selected from indium tin oxide (ITO), indium zinc oxide (IZO) in which zinc oxide (ZnO) is mixed in indium oxide, a conductive material in which silicon oxide (SiO₂) is mixed in indium oxide, organic indium, organotin, or the like. Alternatively, the wire included in the TFT, the gate electrode, the pixel electrode 806, and the counter electrode 823 can be selected from a metal such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), or copper (Cu), an alloy thereof, and metal nitride thereof.

Such a counter substrate 820 is attached to the insulating substrate 801 by using a sealing material 828. The sealing material 828 can be drawn over the insulating substrate 801 or the counter substrate 820 by using a dispenser or the like. Further, a spacer 825 is provided in a part of the pixel portion 705 and the driver circuit portion 708 in order to hold a space between the insulating substrate 801 and the counter substrate 820. The spacer 825 has a shape such as a columnar shape or a spherical shape.

A liquid crystal 811 is injected between the insulating substrate 801 and the counter substrate 820 attached to each other in this manner. It is preferable to inject the liquid crystal in vacuum. The liquid crystal 811 can be formed by a method other than the injecting method. For example, the liquid crystal 811 may be dropped and then the counter substrate 820 may be attached. Such a dropping method is preferably employed when using a large substrate to which the injecting method cannot be applied easily.

The liquid crystal 811 includes a liquid crystal molecule of which tilt is controlled by the pixel electrode 806 and the counter electrode 823. Specifically, the tilt of the liquid crystal molecule is controlled by a voltage applied to the pixel electrode 806 and the counter electrode 823. Such a control is preformed using a control circuit provided in the driver circuit portion 708. It is to be noted that the control circuit is not necessarily formed over the insulating substrate 801 and a circuit connected through a connecting terminal 810 may be used. The connecting terminal 810 is electrically connected to the connecting terminals provided in the first connecting edge 106 and the second connecting edge 107, described in Embodiment Mode and Embodiments 1 to 3. At this time, an anisotropic conductive film containing conductive particles can be used for the connection to the connecting terminal 810. The counter electrode 823 is electrically connected to a part of the connecting terminal 810; therefore a potential of the counter electrode 823 can be common. For example, a bump 837 can be used for the conduction.

Next, description will be made of a structure of a backlight unit 852. The backlight unit 852 includes a cold cathode tube, a hot cathode tube, a diode, an inorganic EL, or an organic EL as a light source 831 which emits fluorescence, a lamp reflector 832 to effectively lead fluorescence to a light guide plate 835, the light guide plate 835 by which light is totally reflected and led to the entire surface, a diffusing plate 836 for reducing variations in brightness, and a reflective plate 834 for reusing light leaked under the light guide plate 835.

A control circuit for controlling the luminance of the light source 831 is connected to the backlight unit 852. The luminance of the light source 831 can be controlled by a signal supplied from the control circuit.

A polarizing plate 816 is provided between the insulating substrate 801 and the backlight unit 852, and a polarizing plate 821 is provided over the counter substrate 820 as well. The polarizing plates 816 and 821 may have a retardation film, and are attached to the insulating substrate 801 and the counter substrate 820, respectively.

By applying such a liquid crystal display panel to the present invention, a high-performance display module with a high-performance display panel can be provided. In addition, an electronic device including a high-performance display module can be provided.

### Embodiment 5

In this embodiment, a structure of a self-luminous display panel which is applied to a display panel constituting the display module of the present invention described in Embodiment Mode and Embodiments 1 to 3 will be described. It is to be noted that the same portions as in FIG. 8 described in Embodiment 4 are denoted by the same reference numerals, and the repeated description will be omitted.

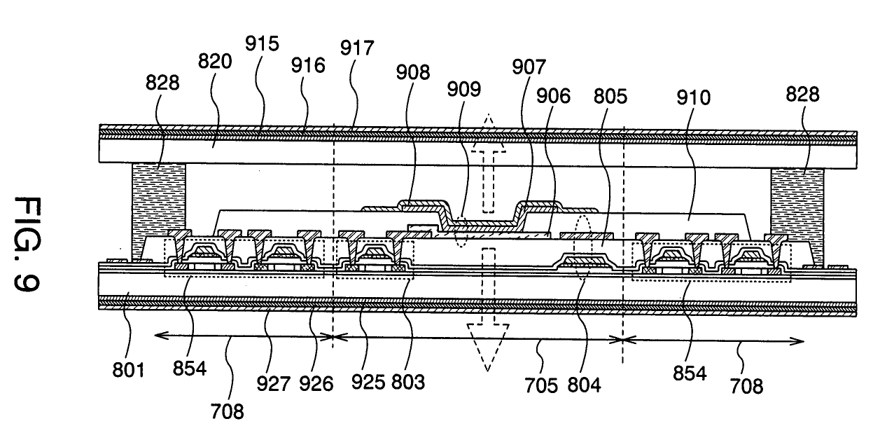

FIG. 9 shows a cross-sectional view of the self-luminous display panel constituting the display module of the present invention.

The self-luminous display panel can be mainly divided into a pixel portion 705 and a driver circuit portion 708. A thin film transistor provided in the pixel portion 705 is used as a switching element or a driving element. Thin film transistors provided in the driver circuit portion 708 are used as a CMOS circuit 854. The CMOS circuit 854 is constituted by a P-channel TFT and an N-channel TFT. A switching TFT 803 can be controlled by the CMOS circuit 854 provided in the driver circuit portion 708.

A first electrode 906 which is connected to either a source electrode or a drain electrode of the TFT as a driving element is formed. The first electrode 906 is formed using a material having a light-transmitting property. As the material having a light-transmitting property, indium tin oxide (ITO), zinc oxide (ZnO), indium zinc oxide (IZO), zinc oxide added with gallium (GZO), or the like can be given. In addition, an alkali metal such as Li or Cs, an alkaline earth metal such as Mg, Ca, or Sr, an alloy containing these (Mg: Ag, Al: Li, Mg: In, or the like), and a compound of these (calcium fluoride, calcium nitride) may also be used. Furthermore, a material with a non-light-transmitting property such as a rare earth metal, Yb or Er for example, may be used for the first electrode 906, because a light-transmitting property can be obtained by making the film thickness very thin.

An insulating layer 910 is formed so as to cover an edge of the first electrode 906. The insulating layer 910 can be formed in a similar way to the interlayer insulating film 805. An opening is provided in the insulating layer 910 such that the insulating layer 910 covers the edge of the first electrode 906. A side face of the opening may be tapered so that a breakage of a layer to be formed later can be prevented. When a non-photosensitive resin or a photosensitive resin is used for the insulating layer 910, for example, the side face of the opening can be tapered by an exposure condition.

After that, an electroluminescence layer 907 is formed over the opening of the insulating layer 910. The electroluminescence layer 907 includes layers having respective functions, specifically: a hole injecting layer; a hole transporting layer; a light emitting layer; an electron transporting layer; and an electron injecting layer. However, the boundary between each layer is not necessarily clear, and some part thereof may be mixed.

Specific examples of the materials which form a light emitting layer are, when light emission of a red-based color is required, 4-dicyanomethylene-2-isopropyl-6-[2-(1, 1,7,7-tetramethyljulolidine-9-yl)ethenyl]-4H-pyran (abbreviation: DCJTI); 4-dicyanomethylene-2-methyl-6-[2-(1,1,7,7-tetramethyljulolidine-9-yl)ethenyl]-4H-pyran (abbreviation: DCJT); 4-dicyanomethylene-2-tert-butyl-6-[2-(1,1,7,7-tetramethyljulolidine-9-yl)ethenyl]-4H-pyran (abbreviation: DCJTB); periflanthene; 2,5-dicyano-1,4-bis[2-(10-methoxy-1,1,7,7-tetramethyljulolidine-9-yl)ethenyl]benzene, bis[2,3-bis(4-fluorophenyl)quinoxalinato]iridium(acetylacetonato) (abbreviation: Ir[Fdpq]₂acac), and the like can be used for the light emitting layer. However, the material is not limited to these and a substance which exhibits light emission with a peak of an emission spectrum at 600 to 700 nm can be used.

When light emission of a green-based color is required, N,N′-dimethylquinacridon (abbreviation: DMQd), coumarin 6, coumarin 545T, tris(8-quinolinolato)aluminum (abbreviation: Alq₃), or the like can be used for the light emitting layer. However, the material is not limited to these and a substance which exhibits light emission with a peak of an emission spectrum at 500 to 600 nm can be used.

When light emission of a blue-based color is required, 9,10-bis(2-naphthyl)-tert-butylanthracene (abbreviation: t-BuDNA), 9,9′-biantryl,9,10-diphenylanthracene (abbreviation: DPA), 9,10-bis(2-naphthyl)anthracene (abbreviation: DNA), bis(2-methyl-8-quinolinolato)-4-phenylphenolato-gallium (abbreviation: BGaq), bis(2-methyl-8-quinolinolato)-4-phenylphenolato-aluminum (abbreviation: BAlq), or the like can be used for the light emitting layer. However, the material is not limited to these and a substance which exhibits light emission with a peak of an emission spectrum at 400 to 500 nm can be used.

When light emission of a white-based color is required, TPD (aromatic diamine), 3-(4-tert-butylphenyl)-4-phenyl-5-(4-biphenylyl)-1,2,4-triazole (abbreviation: TAZ), tris(8-quinolinolato)aluminum (abbreviation: Alq₃), Alq₃ doped with Nile Red which is a red light emission pigment, and Alq₃ may be stacked by a vapor deposition method or the like.

After that, a second electrode 908 is formed. The second electrode 908 can be formed in a similar manner to the first electrode 906. In this way, a light emitting element 909 which includes the first electrode 906, the electroluminescence layer 907, and the second electrode 908 can be formed.

At this time, since the first electrode 906 and the second electrode 908 each have a light-transmitting property, light can be emitted from the electroluminescence layer 907 in both directions. A self-luminous display panel that can emit light in both directions can be referred to as a dual emission type self-luminous display panel.

After that, the insulating substrate 801 and the counter substrate 820 are attached to each other with a sealing material 828. In this embodiment, the sealing material 828 is provided over a part of the driver circuit portion 708, so that the frame size can be reduced. Needless to say, arrangement of the sealing material 828 is not limited thereto, and the sealing material 828 may be provided outside of the driver circuit portion 708.

A space formed by attaching the insulating substrate 801 and the counter substrate 820 is filled with an inert gas such as nitrogen. Alternatively, the space is filled with a highly hygroscopic resin material having a light-transmitting property. As a result, moisture and oxygen which cause deterioration of the light emitting element 909 can be prevented from entering. In addition, a spacer may be provided in order to keep a distance between the insulating substrate 801 and the counter substrate 820, and the spacer may be provided with a hygroscopic property. The spacer has a spherical shape or a columnar shape.

A color filter and a black matrix may be provided for the counter substrate 820. By using the color filter, full color display is possible even when a mono-color light emitting layer, a white color light emitting layer for example, is used. When light emitting layers for RGB are used, a wavelength of the emitted light can be controlled by the color filter, and the display can provide high image quality. Furthermore, by using the black matrix, reflection of external light caused by a wiring or the like can be reduced.

A retardation plate 925, a first polarizing plate 926, and a second polarizing plate 927 can be provided over an outer surface of the insulating substrate 801. A retardation plate 915, a first polarizing plate 916, and a second polarizing plate 917 are provided over an outer surface of the counter substrate 820. That is, a circularly polarizing plate having a polarizing plate and a wave plate is provided over each outer surface of the insulating substrate 801 and the counter substrate 820. The circularly polarizing plate can prevent external light reflection caused by electrodes.

Although a mode in which the driver circuit portion is formed over the insulating substrate 801 is shown in this embodiment, an IC circuit formed of a silicon wafer may be used for the driver circuit portion. In this case, a video signal or the like from the IC circuit can be input to the switching TFT 803 via a connecting terminal or the like.

It is to be noted that, although an active-type self-luminous display panel is used for the explanation in this embodiment, a passive-type self-luminous display panel may be used as well.

By applying such a self-luminous display panel described above to the present invention, a high-performance display module with a high-performance display module can be provided. In addition, an electronic device including a high-performance display module can be provided.

### Embodiment 6

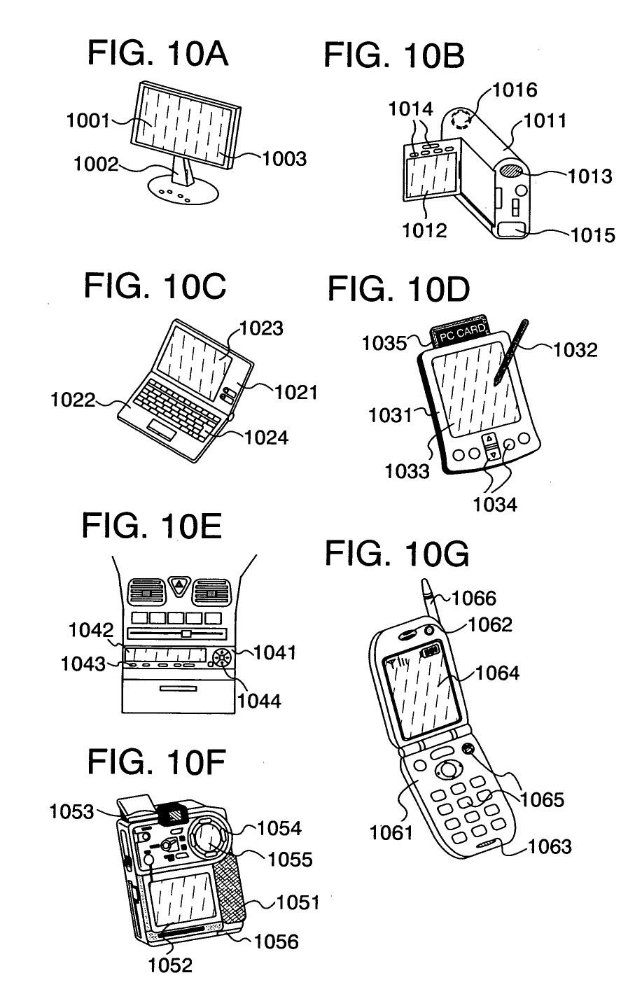

In this embodiment, examples of electronic devices which are manufactured using the display module of the present invention will be described with reference to FIGS. 10A to 10G.

As electronic devices manufactured using the present invention, there are cameras such as a video camera and a digital camera, a goggle type display (head mounted display), a navigation system, an audio reproducing device (a car audio, an audio component or the like), a notebook personal computer, a game machine, a portable information terminal (a mobile computer, a mobile phone, a mobile game machine, an electronic book, or the like), an image reproducing device having a recording medium (specifically, a device for reproducing a recording medium such as a digital versatile disk (DVD) and having a display for displaying the reproduced image), and the like. Specific examples of these electronic devices are shown in FIGS. 10A to 10G.

FIG. 10A is a display device, which includes a housing 1001, a supporting base 1002, and a display portion 1003. A display portion using the display module of the present invention can be applied to the display portion 1003. By using the present invention, an inexpensive and high-performance display can be realized.

FIG. 10B is a video camera, which includes a main body 1011, a display portion 1012, an audio input portion 1013, operation switches 1014, a battery 1015, an image receiving portion 1016, and the like. A display portion using the display module of the present invention can be applied to the display portion 1012. By using the present invention, an inexpensive and high-performance video camera can be realized.

FIG. 10C is a laptop personal computer, which includes a main body 1021, a housing 1022, a display portion 1023, a keyboard 1024, and the like. A display portion using the display module of the present invention can be applied to the display portion 1023. By using the present invention, an inexpensive and high-performance personal computer can be realized.

FIG. 10D is a portable information terminal, which includes a main body 1031, a stylus 1032, a display portion 1033, operation buttons 1034, an external interface 1035, and the like. A display portion using the display module of the present invention can be applied to the display portion 1033. By using the present invention, an inexpensive and high-performance portable information terminal can be realized.

FIG. 10E is an audio reproducing device. Specifically, it is an in-car audio system, which includes a main body 1041, a display portion 1042, operation switches 1043 and 1044, and the like. A display portion using the display module of the present invention can be applied to the display portion 1042. Although an in-car audio system is given as an example here, the present invention may be applied to a portable audio system or an audio system for household use. By using the present invention, an inexpensive and high-performance audio reproducing device can be realized.

FIG. 10F is a digital camera, which includes a main body 1051, a display portion A 1052, an eye piece 1053, operation switches 1054, a display portion B 1055, a battery 1056, and the like. A display portion using the display module of the present invention can be applied to each of the display portions A 1052 and B 1055. By using the present invention, an inexpensive and high-performance digital camera can be realized.

FIG. 10G is a mobile phone, which includes a main body 1061, an audio outputting portion 1062, an audio inputting portion 1063, a display portion 1064, operation switches 1065, an antenna 1066, and the like. A display portion using the display module of the present invention can be applied to the display portion 1064. By using the present invention, an inexpensive and high-performance mobile phone can be realized.

A semiconductor device and a display panel that are used in these electronic devices can use a heat-resistant plastic substrate as well as a glass substrate. As a result, the electronic devices can be even lighter.

The present invention is not limited to the above-described electronic devices, and various electronic devices can be manufactured using the display module described in Embodiment Mode and Embodiments 1 to 5. In this way, inexpensive and high-performance electronic devices can be realized.

This application is based on Japanese Patent Application serial no. 2005-350046 filed in Japan Patent Office on Dec., 2nd, in 2005, the entire contents of which are hereby incorporated by reference.

1. A display module comprising:
a stacked printed circuit board, and
a control circuit mounted on the stacked printed circuit board,
wherein:
the stacked printed circuit board includes at least a first printed wiring board, a second printed wiring board, and a flexible insulating substrate interposed between the first printed wiring board and the second printed wiring board,
the flexible insulating substrate includes at least a first connecting portion and a second connecting portion,
a display panel is electrically connected to one of the first connecting portion and the second connecting portion,
the control circuit includes a memory, and
the control circuit supplies an electrical signal to the one of the first connecting portion and the second connecting portion in accordance with a data stored in the memory.

2. A display module according to claim 1, wherein the data stored in the memory is information about a function and a configuration of a logic circuit included in the control circuit.

3. A display module according to claim 1, wherein a first information and a second information are inputted to a software, wherein the software outputs a third information to the memory, wherein the first information is about an electric signal that is required for driving the display panel, wherein the second information is about a layout of input and output terminals which is electrically connected to the display panel, and wherein the third information is about a function and a configuration of a logic circuit included in the control circuit.

4. A display module according to claim 1, wherein a terminal of the display panel is electrically connected to one of a terminal of the first connecting portion and the second connecting portion.

5. A display module according to claim 1, wherein the control circuit is any one of a field programmable gate array, a programmable logic device, and a complex programmable logic device.

6. A display module according to claim 1, wherein the memory is an EEPROM.

7. A display module according to claim 1, wherein the display panel includes a thin film transistor.

8. A display module according to claim 1, wherein the display panel includes at least one of a liquid crystal and a light emitting element.

9. A display module according to claim 1, further comprising a CPU.

10. An electronic device using a display module according to claim 1.

11. A display module comprising:
a stacked printed circuit board, and
a control circuit mounted on the stacked printed circuit board,
wherein:
the stacked printed circuit board includes at least a first printed wiring board, a second printed wiring board, and a flexible insulating substrate interposed between the first printed wiring board and the second printed wiring board,
the flexible insulating substrate includes at least a first connecting portion and a second connecting portion,
at least one of a first display panel and a second display panel is electrically connected to one of the first connecting portion and the second connecting portion,
the control circuit includes a memory, and
the control circuit supplies an electrical signal to the one of the first connecting portion and the second connecting portion in accordance with a data stored in the memory.

12. A display module according to claim 11, wherein the data stored in the memory is information about a function and a configuration of a logic circuit included in the control circuit.

13. A display module according to claim 11, wherein a first information and a second information are inputted to a software, wherein the software outputs a third information to the memory, wherein the first information is about an electric signal that is required for driving one of the first display panel and the second display panel, wherein the second information is about a layout of input and output terminals which is electrically connected to the one of the first display panel and the second display panel, and wherein the third information is about a function and a configuration of a logic circuit included in the control circuit.

14. A display module according to claim 11, wherein a terminal of the first display panel and the second display panel is electrically connected to one of a terminal of the first connecting portion and the second connecting portion.

15. A display module according to claim 11, wherein the control circuit is any one of a field programmable gate array, a programmable logic device, and a complex programmable logic device.

16. A display module according to claim 11, wherein the memory is an EEPROM.

17. A display module according to claim 11, wherein each of the first display panel and the second display panel includes a thin film transistor.

18. A display module according to claim 11, wherein each of the first display panel and the second display panel includes at least one of a liquid crystal and a light emitting element.

19. A display module according to claim 11, further comprising a CPU.

20. An electronic device using a display module according to claim 11.

21. A display module comprising:
a stacked printed circuit board, and
a control circuit mounted on the stacked printed circuit board,
wherein:
the stacked printed circuit board includes at least a first printed wiring board, a second printed wiring board, and a flexible insulating substrate interposed between the first printed wiring board and the second printed wiring board,
the flexible insulating substrate includes at least a first connecting portion and a second connecting portion,
a display panel is electrically connected to one of the first connecting portion and the second connecting portion,
the control circuit includes a memory,
the control circuit supplies an electrical signal to the one of the first connecting portion and the second connecting portion in accordance with a data stored in the memory, and
the control circuit changes an electrical signal that is supplied to the first connecting portion and the second connecting portion in accordance with the data stored in the memory.

22. A display module according to claim 21, wherein the data stored in the memory is information about a function and a configuration of a logic circuit included in the control circuit.

23. A display module according to claim 21, wherein a first information and a second information are inputted to a software, wherein the software outputs a third information to the memory, wherein the first information is about an electric signal that is required for driving the display panel, wherein the second information is about a layout of input and output terminals which is electrically connected to the display panel, and wherein the third information is about a function and a configuration of a logic circuit included in the control circuit.

24. A display module according to claim 21, wherein a terminal of the display panel is electrically connected to one of a terminal of the first connecting portion and the second connecting portion.

25. A display module according to claim 21, wherein the control circuit is any one of a field programmable gate array, a programmable logic device, and a complex programmable logic device.

26. A display module according to claim 21, wherein the memory is an EEPROM.

27. A display module according to claim 21, wherein the display panel includes a thin film transistor.

28. A display module according to claim 21, wherein the display panel includes at least one of a liquid crystal and a light emitting element.

29. A display module according to claim 21, further comprising a CPU.

30. An electronic device using a display module according to claim 21.

31. A display module comprising:
a stacked printed circuit board, and
a control circuit mounted on the stacked printed circuit board,
wherein:
the stacked printed circuit board includes at least a first printed wiring board, a second printed wiring board, and a flexible insulating substrate interposed between the first printed wiring board and the second printed wiring board,
the flexible insulating substrate includes at least a first connecting portion and a second connecting portion,
at least one of a first display panel and a second display panel is electrically connected to one of the first connecting portion and the second connecting portion,
the control circuit includes a memory,
the control circuit supplies an electrical signal to the one of the first connecting portion and the second connecting portion in accordance with a data stored in the memory, and
the control circuit changes an electrical signal that is supplied to the first connecting portion and the second connecting portion in accordance with the data stored in the memory.

32. A display module according to claim 31, wherein the data stored in the memory is information about a function and a configuration of a logic circuit included in the control circuit.

33. A display module according to claim 31, wherein a first information and a second information are inputted to a software, wherein the software outputs a third information to the memory, wherein the first information is about an electric signal that is required for driving one of the first display panel and the second display panel, wherein the second information is about a layout of input and output terminals which is electrically connected to the one of the first display panel and the second display panel, and wherein the third information is about a function and a configuration of a logic circuit included in the control circuit.

34. A display module according to claim 31, wherein a terminal of the display panel is electrically connected to one of a terminal of the first connecting portion and the second connecting portion.

35. A display module according to claim 31, wherein the control circuit is any one of a field programmable gate array, a programmable logic device, and a complex programmable logic device.

36. A display module according to claim 31, wherein the memory is an EEPROM.

37. A display module according to claim 31, wherein each of the first display panel and the second display panel includes a thin film transistor.

38. A display module according to claim 31, wherein each of the first display panel and the second display panel includes at least one of a liquid crystal and a light emitting element.

39. A display module according to claim 31, further comprising a CPU.

40. An electronic device using a display module according to claim 31.
